(19) United States
(12) Patent Application Publication
(10) Pub. No.: US 2026/0212313 A1
(43) Pub. Date: Jul. 23, 2026

(54) DELIVERY PLAN DETERMINATION DEVICE, DELIVERY PLAN DETERMINATION METHOD, AND COMPUTER PROGRAM

(71) Applicants: SUMITOMO ELECTRIC INDUSTRIES, LTD., Osaka-shi, Osaka (JP); WASEDA UNIVERSITY, Tokyo (JP)

(72) Inventors: Yui TSUYUMINE, Osaka-shi (JP); Takeshi HACHIKAWA, Osaka-shi (JP); Tomoyuki KITADA, Osaka-shi (JP); Kenichi MASUSA, Osaka-shi (JP); Nozomu TOGAMA, Tokyo (JP); Tatsuhiko SHIRAI, Tokyo (JP); Masashi TAWADA, Tokyo (JP); Yuta YACHI, Tokyo (JP)

(73) Assignees: SUMITOMO ELECTRIC INDUSTRIES, LTD., Osaka-shi, Osaka (JP); WASEDA UNIVERSITY, Tokyo (JP)

(21) Appl. No.: 19/142,324

(22) PCT Filed: Dec. 11, 2023
(86) PCT No.: PCT/JP2023/044134

§ 371 Date: Jun. 23, 2025

(30) Foreign Application Priority Data
Dec. 26, 2022 (JP) 2022-207861

(51) Int. Cl. G06Q 10/083; G06Q 10/047

(52) U.S. Cl. CPC G06Q 10/0843; G06Q 10/047; G06Q 10/08355

(57) ABSTRACT

A package delivery plan determined by acquiring objective function including first to ninth functions, and optimizing objective function by using annealing type quantum computer. First function indicates required delivery time, second function indicates number of delivery points, third function prohibits traveling between points in time shorter than required travel time, fourth function indicates number of visits of each vehicle to each delivery point is one or less, and prohibits plurality of vehicles from visiting each delivery point in plurality of time slots, fifth function prohibits plurality of vehicles from visiting each delivery point in each time slot, sixth function prohibits each vehicle from visiting departure, delivery and return point before departure time of vehicle from departure point, seventh function prohibits each vehicle from visiting departure, delivery and return point after return time to return point, eighth function prohibits each vehicle from visiting departure point plurality of times, and ninth function prohibits each vehicle from visiting return point plurality of times.

### TECHNICAL FIELD

The present disclosure relates to a delivery plan determination device, a delivery plan determination method, and a computer program. This application claims priority on Japanese Patent Application No. 2022-207861 filed on Dec. 26, 2022, the entire content of which is incorporated herein by reference.

### BACKGROUND ART

A method for creating operation plans for production facilities in a factory using an annealing machine has been proposed (see Patent Literature 1, for example). An annealing machine is also called an Ising machine or a QUBO (Quadratic Unconstrained Binary Optimization) solver, and implements hardware specialized for combinatorial optimization by using circuitry such as an FPGA (Field-Programmable Gate Array) or a GPU (Graphics Processing Unit).

In addition, practical use of a quantum computer that can instantly solve combinatorial optimization problems has become realistic. The above operation plans can also be instantly created by using such a quantum computer.

### CITATION LIST

### Patent Literature

PATENT LITERATURE 1: Japanese Laid-Open Patent Publication No. 2020-140615

### SUMMARY OF THE INVENTION

A delivery plan determination device according to one aspect of the present disclosure is a delivery plan determination device that determines a delivery plan for delivering packages using a plurality of vehicles from a departure point to a return point via a package delivery point, including: an objective function acquisition unit configured to acquire an objective function including a first function, a second function, a third function, a fourth function, a fifth function, a sixth function, a seventh function, an eighth function, and a ninth function described below; and a delivery plan determination unit configured to determine the delivery plan by optimizing the objective function using an annealing type quantum computer or an Ising machine.
First function: a function indicating a required package delivery time
Second function: a function indicating the number of the delivery points
Third function: a penalty function that prohibits each vehicle from traveling, in a time shorter than a required travel time, between points to which each vehicle may travel
Fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots
Fifth function: a penalty function that prohibits the plurality of vehicles from visiting each delivery point in each time slot
Sixth function: a penalty function that prohibits each vehicle from visiting the departure point, the delivery point, and the return point before a departure time of the vehicle from the departure point
Seventh function: a penalty function that prohibits each vehicle from visiting the departure point, the delivery point, and the return point after a return time to the return point
Eighth function: a penalty function that prohibits each vehicle from visiting the departure point a plurality of times
Ninth function: a penalty function that prohibits each vehicle from visiting the return point a plurality of times

### BRIEF DESCRIPTION OF DRAWINGS

FIG. 1 shows an example of an overall configuration of a delivery plan determination system according to Embodiment 1 of the present disclosure.

FIG. 2 shows an example of a package delivery plan.

FIG. 3 is a block diagram showing an example of a configuration of a delivery plan determination device according to Embodiment 1 of the present disclosure.

FIG. 4 is a diagram illustrating a first function.

FIG. 5 is a diagram illustrating a second function.

FIG. 6 is a diagram illustrating a third function.

FIG. 7 is a diagram illustrating a fourth function.

FIG. 8 is a diagram illustrating a fifth function.

FIG. 9 is a diagram illustrating a sixth function.

FIG. 10 is a diagram illustrating a seventh function.

FIG. 11 is a diagram illustrating an eighth function.

FIG. 12 is a diagram illustrating a ninth function.

FIG. 13 is a sequence diagram showing an example of the operation of the delivery plan determination system according to Embodiment 1 of the present disclosure.

FIG. 14 is a block diagram showing an example of the configuration of a delivery plan determination device according to Embodiment 2 of the present disclosure.

FIG. 15 shows an example of designated delivery time information for packages.

FIG. 16 shows an example of decision variables.

FIG. 17 is a sequence diagram showing an example of the operation of a delivery plan determination system according to Embodiment 2 of the present disclosure.

### DETAILED DESCRIPTION

### Problems to be Solved by the Present Disclosure

Various methods for determining delivery plans for packages using vehicles have been proposed. However, in the method disclosed in Patent Literature 1, traveling between points is not reflected in the combinatorial optimization problem. Therefore, the above method cannot be directly applied to the creation of delivery plans.

The present application has been made in view of these circumstances, and an object of the present disclosure is to provide a delivery plan determination device, a delivery plan determination method, and a computer program capable of quickly determining a delivery plan.

### Effects of the Present Disclosure

According to the present disclosure, a delivery plan can be quickly determined.

### Description of Embodiment of the Present Disclosure

First, the outlines of embodiments of the present disclosure are listed and described.
(1) A delivery plan determination device according to an embodiment of the present disclosure is a delivery plan determination device that determines a delivery plan for delivering packages using a plurality of vehicles from a departure point to a return point via a package delivery point. The device includes: an objective function acquisition unit configured to acquire an objective function including a first function, a second function, a third function, a fourth function, a fifth function, a sixth function, a seventh function, an eighth function, and a ninth function described below; and a delivery plan determination unit configured to determine the delivery plan by optimizing the objective function using an annealing type quantum computer or an Ising machine.
First function: a function indicating a required package delivery time
Second function: a function indicating the number of the delivery points
Third function: a penalty function that prohibits each vehicle from traveling, in a time shorter than a required travel time, between points to which each vehicle may travel
Fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots
Fifth function: a penalty function that prohibits the plurality of vehicles from visiting each delivery point in each time slot
Sixth function: a penalty function that prohibits each vehicle from visiting the departure point, the delivery point, and the return point before a departure time of the vehicle from the departure point
Seventh function: a penalty function that prohibits each vehicle from visiting the departure point, the delivery point, and the return point after a return time to the return point
Eighth function: a penalty function that prohibits each vehicle from visiting the departure point a plurality of times
Ninth function: a penalty function that prohibits each vehicle from visiting the return point a plurality of times

According to this configuration, the objective function is optimized using an annealing type quantum computer or an Ising machine. The objective function includes the first function relating to the required package delivery time and the second function relating to the number of package delivery points. Furthermore, the objective function includes the penalty functions indicated as the third to ninth functions. These penalty functions indicate the constraints for vehicles when the vehicles travel between points. Therefore, it is possible to quickly determine the package delivery plan that optimizes the required package delivery time and the number of package delivery points while satisfying the constraints.
(2) In the above (1), the objective function may be represented by a sum of functions obtained by multiplying the first function, the second function, the third function, the fourth function, the fifth function, the sixth function, the seventh function, the eighth function, and the ninth function by predetermined weight coefficients, respectively.

For example, by setting the weights for the third through ninth functions to values that are sufficiently larger than the weights for the first and second functions (e.g., 100 to 1000 times larger), the value of the objective function can be increased when the constraints are not satisfied. Therefore, a package delivery plan that reliably satisfies the constraints can be determined by minimizing the objective function.
(3) In the above (1) or (2), the third function may be represented by H3 as follows:

$$\begin{matrix}[ Math . 1 ] & \\ {H}_{3} = {\sum }_{k ∈ K} {\sum }_{{τ}_{1} ∈ T} {\sum }_{\begin{matrix}{p}_{1} ∈ P \\ {p}_{1} \neq {e}_{k}\end{matrix}} ( {q}_{{τ}_{1} , {p}_{1}}^{( k )} {\sum }_{\begin{matrix}{p}_{2} ∈ P \\ {p}_{2} \neq {p}_{1} , {s}_{k}\end{matrix}} {\sum }_{{τ}_{2} = {τ}_{1}}^{{τ}_{1} + {c}_{{p}_{1} {p}_{2}}^{( k , {τ}_{1} )} - 1} {q}_{{τ}_{2} , {p}_{2}}^{( k )} ) & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${s}_{k} : departure point of vehicle k ( element of P )$$

$${e}_{k} : return point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

$${( {c}_{{p}_{1} {p}_{2}}^{( k , τ )} )}_{1 \leq {p}_{1} \neq p = 2 \leq N} : \begin{matrix}number of time slots required after departure \\ from point {p}_{1} and before departure from next point {p}_{2}\end{matrix}$$

$${c}_{{p}_{1} {p}_{2}}^{( k , τ )} = ⌊ \frac{{t}_{{p}_{1} {p}_{2}}^{( move )} + {t}_{{p}_{2}}^{( wait )} + {t}_{{p}_{2}}^{( work )} + {t}_{k}^{( rest )}}{Δ t} ⌋$$

$${t}_{{p}_{1} {p}_{2}}^{( move )} : travel time from {p}_{1} to point {p}_{2}$$

$${t}_{{p}_{2}}^{( wait )} : waiting time at point {p}_{2}$$

$${t}_{{p}_{2}}^{( work )} : work time at point {p}_{2}$$

$${t}_{k}^{( rest )} : break time designated to vehicle k$$

$$Δ t : time in time slot$$

According to this configuration, the third function can be formulated as Hamiltonian H3 by using a decision variable represented by equation 1 as follows. The decision variable indicates, with 0 or 1, whether or not the vehicle k visits the point p in the time slot τ. Therefore, the objective function can be optimized by using the annealing type quantum computer or the Ising machine.

$$\begin{matrix}[ Math . 2 ] & \\ {q}_{τ , p}^{( k )} & ( Equation 1 )\end{matrix}$$

(4) In any of the above (1) to (3), the fourth function may be represented by H4 as follows.

$$\begin{matrix}[ Math . 3 ] & \\ {H}_{4} = {\sum }_{{k}_{1} ∈ K} {\sum }_{{τ}_{1} ∈ T} {\sum }_{\begin{matrix}p ∈ P \\ p \neq {s}_{{k}_{1}} , {e}_{{k}_{1}}\end{matrix}} ( {q}_{{τ}_{1} , p}^{( k )} {\sum }_{\begin{matrix}{k}_{2} ∈ K \\ {k}_{2} \geq {k}_{1}\end{matrix}} {\sum }_{\begin{matrix}{τ}_{2} ∈ T \\ {τ}_{2} \neq {τ}_{1}\end{matrix}} {q}_{{τ}_{2} , p}^{( {k}_{2} )} ) & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${s}_{k} : departure point of vehicle k ( element of P )$$

$${e}_{k} : return point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

According to this configuration, the fourth function can be formulated as Hamiltonian H4 by using the decision variable of equation 1 that indicates, with 0 or 1, whether or not the vehicle k visits the point p in the time slot τ. Therefore, the objective function can be optimized by using the annealing type quantum computer or the Ising machine.
(5) In any one of the above (1) to (4), the fifth function may be represented by H5 as follows.

$$\begin{matrix}[ Math . 4 ] & \\ {H}_{5} = {\sum }_{{k}_{1} ∈ K} {\sum }_{τ ∈ T} {\sum }_{\begin{matrix}p ∈ P \\ p \neq {s}_{{k}_{1}} , {e}_{{k}_{1}}\end{matrix}} ( {q}_{τ , p}^{( {k}_{1} )} {\sum }_{\begin{matrix}{k}_{2} ∈ K \\ {k}_{2} > {k}_{1}\end{matrix}} {q}_{τ , p}^{( {k}_{2} )} ) & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${s}_{k} : departure point of vehicle k ( element of P )$$

$${e}_{k} : return point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

According to this configuration, the fifth function can be formulated as Hamiltonian H5 by using the decision variable of equation 1 that indicates, with 0 or 1, whether or not the vehicle k visits the point p in the time slot τ. Therefore, the objective function can be optimized by using the annealing type quantum computer or the Ising machine.
(6) In any of the above (1) to (5), the sixth function may be represented by H6 as follows.

$$\begin{matrix}[ Math . 5 ] & \\ {H}_{6} = {\sum }_{k ∈ K} {\sum }_{{τ}_{2} ∈ T} ( {q}_{{τ}_{2} , {s}_{k}}^{( k )} {{\sum }^{{τ}_{2} - 1}}_{{τ}_{1} = 1} {\sum }_{p ∈ P} {q}_{{τ}_{1} , p}^{( k )} ) & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${s}_{k} : departure point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

According to this configuration, the sixth function can be formulated as Hamiltonian H6 by using the decision variable of equation 1 that indicates, with 0 or 1, whether or not the vehicle k visits the point p in the time slot τ. Therefore, the objective function can be optimized by using the annealing type quantum computer or the Ising machine.
(7) In any of the above (1) to (6), the seventh function may be represented by H7 as follows:

$$\begin{matrix}[ Math . 6 ] & \\ {H}_{7} = {\sum }_{k ∈ K} {\sum }_{{τ}_{1} ∈ T} ( {q}_{{τ}_{1} , {e}_{k}}^{( k )} {{\sum }^{W}}_{{τ}_{2} = {τ}_{1} + 1} {\sum }_{p ∈ P} {q}_{{τ}_{2} , p}^{( k )} ) & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${e}_{k} : return point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

According to this configuration, the seventh function can be formulated as Hamiltonian H7 by using the decision variable of equation 1 that indicates, with 0 or 1, whether or not the vehicle k visits the point p in the time slot τ. Therefore, the objective function can be optimized by using the annealing type quantum computer or the Ising machine.
(8) In any of the above (1) to (7), the eighth function may be represented by H8 as follows:

$$\begin{matrix}[ Math . 7 ] & \\ {H}_{8} = {\sum }_{k ∈ K} {( {\sum }_{τ ∈ T} {q}_{τ , {s}_{k}}^{( k )} - 1 )}^{2} & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${s}_{k} : departure point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

According to this configuration, the eighth function can be formulated as Hamiltonian H8 by using the decision variable of equation 1 that indicates, with 0 or 1, whether or not the vehicle k visits the point p in the time slot τ. Therefore, the objective function can be optimized by using the annealing type quantum computer or the Ising machine.
(9) In any one of the above (1) to (8), the ninth function may be represented by H9 as follows:

$$\begin{matrix}[ Math . 8 ] & \\ {H}_{9} = {\sum }_{k ∈ K} {( {\sum }_{τ ∈ T} {q}_{τ , {e}_{k}}^{( k )} - 1 )}^{2} & \end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${e}_{k} : return point of vehicle k ( element of P )$$

$${q}_{τ , p}^{( k )} = \{ \begin{matrix}1 : vehicle k departs from p in time slot τ \\ 0 : vehicle k does not depart from point p in time slot τ\end{matrix}$$

According to this configuration, the ninth function can be formulated as Hamiltonian H9 by using the decision variable of equation 1 that indicates, with 0 or 1, whether or not the vehicle k visits the point p in the time slot τ. Therefore, the objective function can be optimized by using the annealing type quantum computer or the Ising machine.
(10) In any of the above (1) to (9), the delivery point may be associated with the package and a designated delivery time of the package.

There is a case where different delivery times are designated for a plurality of packages to be delivered to the same delivery point. According to this configuration, if packages have different designated delivery times even for the same delivery point, the objective function can be optimized with the delivery point being treated as different delivery points. Thus, it is possible to determine a delivery plan for delivering packages with different designated delivery times to the same delivery point, without being restricted by the number of visits according to the fourth function.
(11) In any of the above (1) to (10), the objective function includes a decision variable that indicates, with two values, whether or not each vehicle visits each delivery point in each time slot, and the delivery plan determination unit optimizes the objective function after determining, based on a designated delivery time of a package, the value of a decision variable other than the designated delivery time of the package at the delivery point to a value corresponding to no visit.

According to this configuration, the number of decision variables whose values should be determined can be reduced. Thus, a delivery plan in which packages are not delivered during a period in which delivery is prohibited, can be quickly determined.
(12) A delivery plan determination method according to another embodiment of the present disclosure is a delivery plan determination method for determining a delivery plan for delivering packages using a plurality of vehicles from a departure point to a return point via a package delivery point. The method includes: acquiring, by a delivery plan determination device, an objective function including a first function, a second function, a third function, a fourth function, a fifth function, a sixth function, a seventh function, an eighth function, and a ninth function described below; and determining, by the delivery plan determination device, the delivery plan by optimizing the objective function using an annealing type quantum computer or an Ising machine.
First function: a function indicating a required package delivery time
Second function: a function indicating the number of the delivery points
Third function: a penalty function that prohibits each vehicle from traveling, in a time shorter than a required travel time, between points to which each vehicle may travel
Fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots
Fifth function: a penalty function that prohibits the plurality of vehicles from visiting each delivery point in each time slot
Sixth function: a penalty function that prohibits each vehicle from visiting the departure point, the delivery point, and the return point before a departure time of the vehicle from the departure point
Seventh function: a penalty function that prohibits each vehicle from visiting the departure point, the delivery point, and the return point after a return time to the return point
Eighth function: a penalty function that prohibits each vehicle from visiting the departure point a plurality of times
Ninth function: a penalty function that prohibits each vehicle from visiting the return point a plurality of times

This configuration includes the characteristic processes in the above delivery plan determination device, as steps. Therefore, the same functions and effects as those of the delivery plan determination device can be achieved.
(13) A computer program according to another embodiment of the present disclosure is a computer program for causing a computer to function as a delivery plan determination device that determines a delivery plan for delivering packages using a plurality of vehicles from a departure point to a return point via a package delivery point. The program causes the computer to function as: an objective function acquisition unit configured to acquire an objective function including a first function, a second function, a third function, a fourth function, a fifth function, a sixth function, a seventh function, an eighth function, and a ninth function described below; and a delivery plan determination unit configured to determine the delivery plan by optimizing the objective function using an annealing type quantum computer or an Ising machine.
First function: a function indicating a required package delivery time
Second function: a function indicating the number of the delivery points
Third function: a penalty function that prohibits each vehicle from traveling, in a time shorter than a required travel time, between points to which each vehicle may travel
Fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots
Fifth function: a penalty function that prohibits the plurality of vehicles from visiting each delivery point in each time slot
Sixth function: a penalty function that prohibits each vehicle from visiting the departure point, the delivery point, and the return point before a departure time of the vehicle from the departure point
Seventh function: a penalty function that prohibits each vehicle from visiting the departure point, the delivery point, and the return point after a return time to the return point
Eighth function: a penalty function that prohibits each vehicle from visiting the departure point a plurality of times
Ninth function: a penalty function that prohibits each vehicle from visiting the return point a plurality of times

According to this configuration, the computer can be caused to function as the above delivery plan determination device. Therefore, the same functions and effects as those of the delivery plan determination device can be achieved.

### Details of Embodiments of the Present Disclosure

Hereinafter, embodiments of the present disclosure will be described with reference to the drawings. The following embodiments are specific examples of the present disclosure. The numerical values, shapes, materials, components, arrangement and connection configuration of the components, steps, the order of the steps, etc., described in the following embodiments are merely examples, and are not intended to limit the present disclosure. Of the components described in the following embodiments, components which are not included in independent claims are optionally includable components. The drawings are schematic drawings and are not necessarily strict illustrations.

In addition, the same reference signs are given to the same components. Since these components have similar functions and names, descriptions thereof are omitted as appropriate.

### Embodiment 1

### [Overall Configuration of Delivery Plan Determination System]

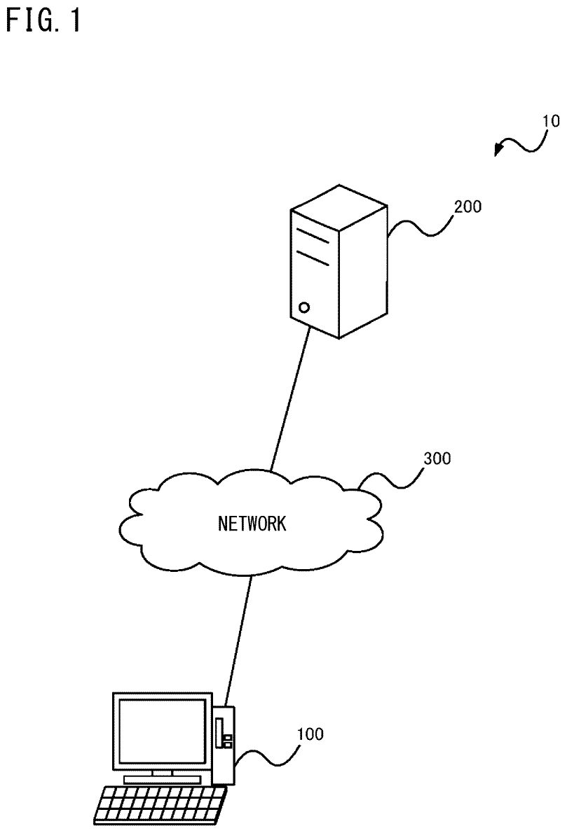

FIG. 1 shows an example of an overall configuration of a delivery plan determination system according to Embodiment 1 of the present disclosure.

A delivery plan determination system 10 includes a delivery plan determination device 100 and a quantum computer 200.

The delivery plan determination device 100 and the quantum computer 200 are connected to each other via a network 300 such as LAN (Local Area Network), WAN (Wide Area Network), or the Internet. However, the delivery plan determination device 100 and the quantum computer 200 may be directly connected to each other via a dedicated line.

The quantum computer 200 is an annealing type quantum computer, and can quickly calculate a solution to a combinatorial optimization problem. A combinatorial optimization problem is formulated as QUBO (Quadratic Unconstrained Binary Optimization) represented by equation 2 as follows. An Ising machine may be used instead of the quantum computer 200. As with the quantum computer 200, an Ising machine can also quickly calculate a solution to a combinatorial optimization problem formulated as QUBO.

$$\begin{matrix}[ Math . 9 ] & \\ {minimize}_{( {x}_{1} , {x}_{2} , … , {x}_{N} ) ∈ {\{ 0 , 1 \}}^{N}} {\sum }_{i} {\sum }_{j} {J}_{i , j} {x}_{i} {x}_{j} + {\sum }_{i} {h}_{i} {x}_{i} + const . = {X}^{T} JX + {h}^{T} X + const . & ( Equation 2 )\end{matrix}$$

In equation 2, xi (xj) is a decision variable, Ji, j, hi are parameters, and const. is a constant.

In QUBO, the value that the decision variable can take is 0 or 1. An objective function of QUBO is a polynomial whose degree is not higher than 2. In addition, there is no explicit constraint in QUBO.

Using the quantum computer 200, the delivery plan determination device 100 determines a package delivery plan for delivering packages with a plurality of vehicles from a departure point to a return point via a package delivery point. That is, the delivery plan determination device 100 creates an objective function of QUBO (described later) and provides the same to the quantum computer 200. The quantum computer 200 probabilistically calculates the value of a decision variable that optimizes (here, minimizes) the objective function. The delivery plan determination device 100 acquires the value of the decision variable from the quantum computer 200 and determines a delivery plan.

Here, points to which the vehicles may travel include a departure point, a delivery point, and a return point.

### [Description of Variables]

Hereinafter, variables in determining a package delivery plan will be described.

In Embodiment 1, a delivery plan in which packages are delivered to more delivery points in a shorter time by using V vehicles within a predetermined period (e.g., from 9:00 to 19:00), is determined.

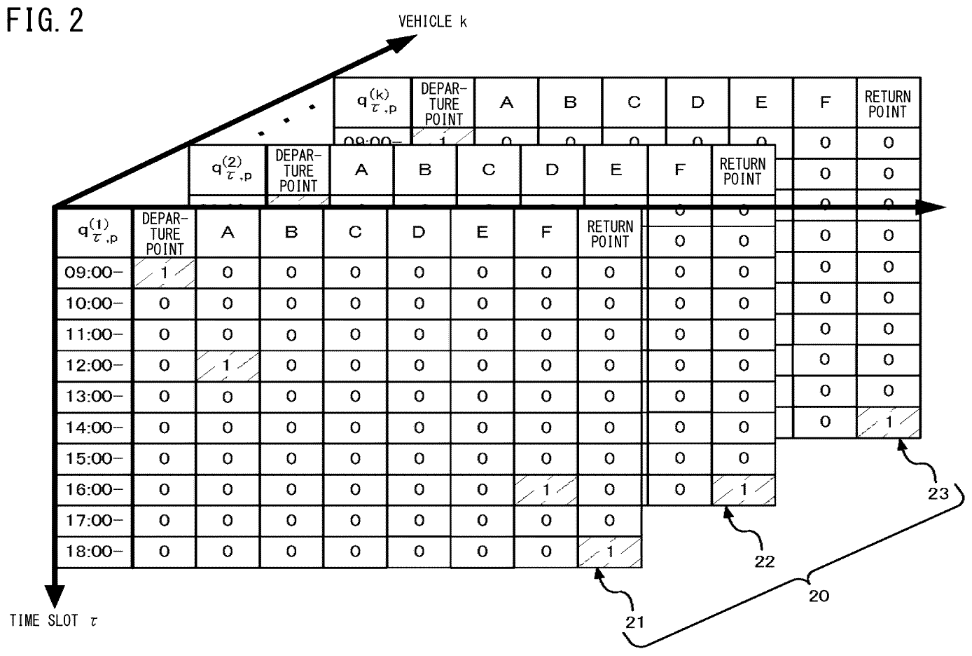

FIG. 2 shows an example of a package delivery plan. A delivery plan 20 is a three-dimensional matrix indicating delivery plans of all vehicles. The delivery plan 20 is composed of a plurality of two-dimensional matrices indicating the delivery plans of the respective vehicles. For example, a delivery plan 21 is the delivery plan for a vehicle 1, a delivery plan 22 is the delivery plan for a vehicle 2, and a delivery plan 23 is the delivery plan for a vehicle V.

In the delivery plan 20, a first axis indicates point p, a second axis indicates time slot τ, and a third axis indicates vehicle k. Time slots τ refer to time slots obtained by dividing a planned time of the delivery plan by a predetermined period (e.g., 1 hour).

Each of cells of the delivery plan 20 indicates a value represented by equation 3 as follows. However, when the point p is a return point, “1” indicates arriving at the return point and “0” indicates not arriving at the return point.

$$\begin{matrix}[ Math . 10 ] & \\ {q}_{τ , p}^{( k )} = \{ \begin{matrix}1 : vehicle k departs from p in time slot τ \\ 0 : vehicle k does not depart from point p in time slot τ\end{matrix} & ( Equation 3 )\end{matrix}$$

$$where$$

$$t ∈ T = \{ 1 , 2 , … , W \} : time slot$$

$$k ∈ K = \{ 1 , 2 , … , V \} : vehicle$$

$$p ∈ P = \{ 1 , 2 , … , N \} : point$$

$${s}_{k} : departure point of vehicle k ( element of P )$$

$${e}_{k} : return point of vehicle k ( element of P )$$

$${( {c}_{{p}_{1} {p}_{2}}^{( k , τ )} )}_{1 \leq {p}_{1} \neq p = 2 \leq N} : \begin{matrix}number of time slots required after departure \\ from point {p}_{1} and before departure from next point {p}_{2}\end{matrix}$$

$$( however , if point {p}_{2} is {e}_{k} , number of time slots required$$

$$after departure from point {p}_{1} and before arrival at next point {e}_{k} )$$

$${c}_{{p}_{1} {p}_{2}}^{( k , τ )} = ⌊ \frac{{t}_{{p}_{1} {p}_{2}}^{( move )} + {t}_{{p}_{2}}^{( wait )} + {t}_{{p}_{2}}^{( work )} + {t}_{k}^{( rest )}}{Δ t} ⌋$$

$${t}_{{p}_{1} {p}_{2}}^{( move )} : travel time from {p}_{1} to point {p}_{2}$$

$${t}_{{p}_{2}}^{( wait )} : waiting time at point {p}_{2}$$

$${t}_{{p}_{2}}^{( work )} : work time at point {p}_{2}$$

$${t}_{k}^{( rest )} : break time designated to vehicle k$$

$$Δ t : time in time slot$$

The travel time, the waiting time, the work time, the break time, and the time of each time slot are known values.

For example, the delivery plan 21 indicates that the vehicle 1 departs from the departure point in the time slot from 9:00, arrives at a delivery point A, and then departs from the delivery point A in the time slot from 12:00. The delivery plan 21 further indicates that the vehicle 1 arrives at a delivery point F and departs from the delivery point F in the time slot from 16:00. The delivery plan 21 further indicates that the vehicle 1 arrives at the return point in the time slot from 18:00.

### [Configuration of Delivery Plan Determination Device 100]

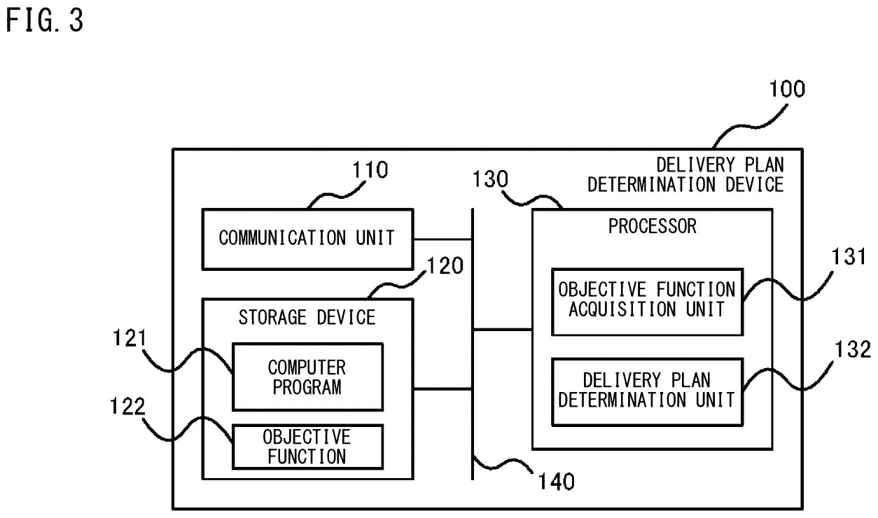

FIG. 3 is a block diagram showing an example of the configuration of the delivery plan determination device 100 according to Embodiment 1 of the present disclosure.

The delivery plan determination device 100 includes a communication unit 110, a storage device 120, and a processor 130. The communication unit 110, the storage device 120, and the processor 130 are connected to each other via an internal bus 140. The delivery plan determination device 100 is a von Neumann computer (classical computer).

The communication unit 110 includes a communication interface for connecting the delivery plan determination device 100 to the network 300 wirelessly or by wire. When the delivery plan determination device 100 and the quantum computer 200 are directly connected to each other, the communication unit 110 includes a communication interface for connecting the delivery plan determination device 100 to the quantum computer 200 wirelessly or by wire.

The storage device 120 is implemented by a volatile memory element such as SRAM (Static Random Access Memory) or DRAM (Dynamic Random Access Memory), a non-volatile memory element such as a flash memory or EEPROM (Electrically Erasable Programmable Read Only Memory), or a magnetic storage device such as a hard disk.

The storage device 120 stores a computer program 121 that is executed by the processor 130. In addition, the storage device 120 stores data that is used or generated when the computer program 121 is executed. For example, the storage device 120 stores an objective function 122 to be optimized by the quantum computer 200.

The processor 130 is implemented by a CPU (Central Processing Unit) or a GPU. The processor 130 includes an objective function acquisition unit 131 and a delivery plan determination unit 132 as functional processing units realized by reading and executing the computer program 121 stored in the storage device 120.

The objective function acquisition unit 131 acquires a QUBO objective function. Specifically, the objective function acquisition unit 131 reads out the objective function 122 from the storage device 120. The objective function 122 is formulated as Hamiltonian H shown in equation 4 as follows. The Hamiltonian H is represented as a sum of functions obtained by multiplying the first function H1, second function H2, third function H3, fourth function H4, fifth function H5, sixth function H6, seventh function H7, eighth function H8, and ninth function H9 by weight w1, weight (−w2), weight w3, weight w4, weight w5, weight w6, weight w7, weight w8, and weight w9, respectively. Here, the weights w1 to w9 are all positive values.

$$\begin{matrix}[ Math . 11 ] & \\ H = {w}_{1} {H}_{1} - {w}_{2} {H}_{2} + {w}_{3} {H}_{3} + {w}_{4} {H}_{4} + {w}_{5} {H}_{5} + {w}_{6} {H}_{6} + {w}_{7} {H}_{7} + {w}_{8} {H}_{8} + {w}_{9} {H}_{9} & ( Equation 4 )\end{matrix}$$

### [First Function]

The first function (Hamiltonian H1) is represented by equation 5 as follows.

$$\begin{matrix}[ Math . 12 ] & \\ {H}_{1} = {\sum }_{k ∈ K} {\sum }_{τ ∈ T} τ ( {q}_{τ , {e}_{k}}^{( k )} - {q}_{τ , {s}_{k}}^{( k )} ) & ( Equation 5 )\end{matrix}$$

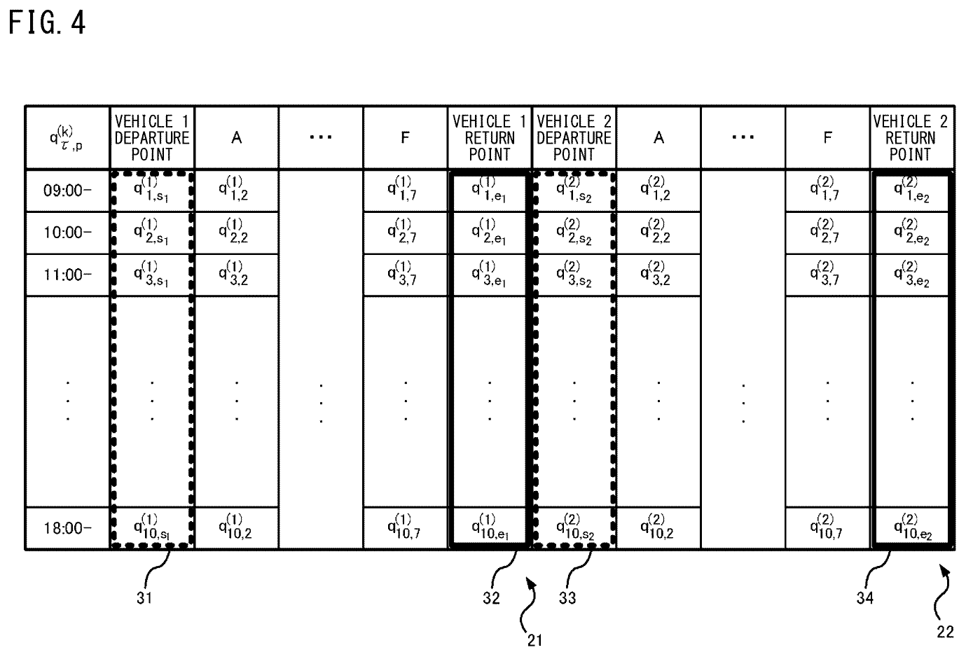

FIG. 4 is a diagram illustrating the first function. FIG. 4 shows an example of the delivery plan 21 for the vehicle 1 and the delivery plan 22 for the vehicle 2. Note that delivery plans for other vehicles are similarly shown. The Hamiltonian H1 indicates a total required time obtained by adding up the required time for each vehicle from departure from the departure point to arrival at the return point for all vehicles.

For example, a time slot to which a cell with value 1 belongs in a frame 31 corresponds to the time when the vehicle 1 departs from the departure point, and a time slot to which a cell with value 1 belongs in a frame 32 corresponds to the time when the vehicle 1 arrives at the return point. Likewise, a time slot to which a cell with value 1 belongs in a frame 33 corresponds to the time when the vehicle 2 departs from the departure point, and a time slot to which a cell with value 1 belongs in a frame 34 corresponds to the time when the vehicle 2 arrives at the return point.

### [Second Function]

The second function (Hamiltonian H2) is represented by equation 6 as follows.

$$\begin{matrix}[ Math . 13 ] & \\ {H}_{2} = {\sum }_{k ∈ K} {\sum }_{τ ∈ T} {{\sum }_{p ∈ P}}_{p \neq {s}_{k} , {e}_{k}} {q}_{τ , p}^{( k )} & ( Equation 6 )\end{matrix}$$

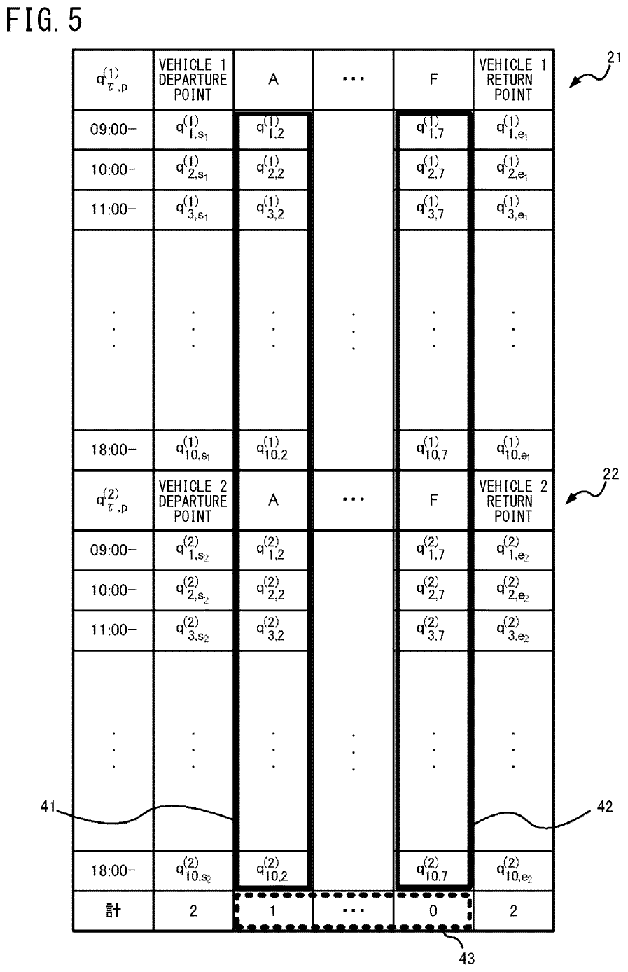

FIG. 5 is a diagram illustrating the second function. FIG. 5 shows an example of the delivery plan 21 for the vehicle 1 and the delivery plan 22 for the vehicle 2. Note that delivery plans for other vehicles are similarly shown. The Hamiltonian H2 represents the total number of visits (the total number of points visited by all vehicles) which is calculated as follows. That is, the number of vehicle visits is calculated for each of package delivery points excluding the departure points and the return point among the points to which the vehicles may travel, and the number of vehicle visits for each delivery point is added up for all the delivery points. The sum of the values of cells in a frame 41 indicates the number of visits to the delivery point A, and the sum of the values of cells in a frame 42 indicates the number of visits to the delivery point F. The number of visits to each delivery point is shown in a frame 43. The sum of the values of cells in the frame 43 is equal to the value of the Hamiltonian H2.

### [Third Function]

The third function (Hamiltonian H3) is represented by equation 7 as follows.

$$\begin{matrix}[ Math . 14 ] & \\ {H}_{3} = {\sum }_{k ∈ K} {\sum }_{{τ}_{1} ∈ T} {{\sum }_{{p}_{1} ∈ P}}_{{p}_{1} \neq {e}_{k}} ( {q}_{{τ}_{1} , {p}_{1}}^{( k )} {{\sum }_{{p}_{2} ∈ P}}_{{p}_{2} \neq {p}_{1} , {s}_{k}} {{\sum }_{{τ}_{2} = {τ}_{1}}}^{{τ}_{1} + {c}_{{p}_{1} {p}_{2}}^{( k , {τ}_{1} )} - 1} {q}_{{τ}_{2} , {p}_{2}}^{( k )} ) & ( Equation 7 )\end{matrix}$$

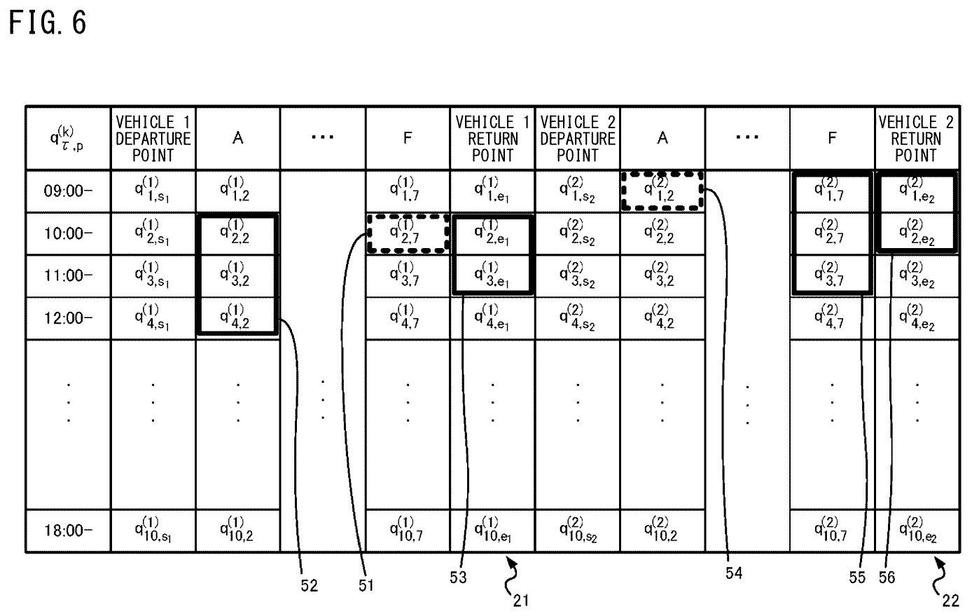

FIG. 6 is a diagram illustrating the third function. FIG. 6 shows an example of the delivery plan 21 for the vehicle 1 and the delivery plan 22 for the vehicle 2. Note that delivery plans for other vehicles are similarly shown.

The Hamiltonian H3 is a penalty function that prohibits each vehicle from traveling, in a time shorter than a required traveling time, between points to which each vehicle may travel.

For example, suppose that the vehicle 1 departs from the delivery point F in the time slot from 10:00. In this case, the value of a cell in a frame 51 is 1. Thereafter, suppose that the vehicle 1 travels toward a certain point. For example, suppose that the vehicle 1 travels from the delivery point F to the delivery point A and the number of time slots required before departure from the delivery point A is 4. In this case, since the vehicle 1 is planned to depart from the delivery point A in the time slot from 13:00, the values of three cells in a frame 52 must be 0. Meanwhile, suppose that the vehicle 1 travels toward the return point of the vehicle 1 and the number of time slots required before arrival at the return point is 3. In this case, since the vehicle 1 is planned to arrive at the return point in the time slot from 12:00, the values of two cells in a frame 53 must be 0.

Likewise, suppose that the vehicle 2 departs from the delivery point A in the time slot from 9:00. In this case, the value of a cell in a frame 54 is 1. Thereafter, suppose that the vehicle 2 travels toward a certain point. For example, suppose that the vehicle 2 travels toward the delivery point F and the number of time slots required before departure from the delivery point F is 4. In this case, since the vehicle 2 is planned to depart from the delivery point F in the time slot from 12:00, the values of cells in a frame 55 must be 0. Meanwhile, suppose that the vehicle 2 travels toward the return point of the vehicle 2 and the number of time slots required before arrival at the return point is 3. In this case, since the vehicle 2 is planned to arrive at the return point in the time slot from 11:00, the values of cells in a frame 56 must be 0.

The Hamiltonian H3 is a function which is 0 when each vehicle is traveling with a time longer than a required travel time between points to which each vehicle may travel, and whose value increases according to combination of points between which the vehicle travels with a time shorter than the required travel time.

The third function can be formulated as Hamiltonian H3 by using the decision variable of equation 3, which indicates whether or not the vehicle k visits the point p in the time slot τ, as 0 or 1. Therefore, the objective function 122 can be optimized by using the quantum computer 200 or an Ising machine.

### [Fourth Function]

The fourth function (Hamiltonian H4) is represented by equation 8 as follows.

$$\begin{matrix}[ Math . 15 ] & \\ {H}_{4} = {\sum }_{{k}_{1} ∈ K} {\sum }_{{τ}_{1} ∈ T} {{\sum }_{p ∈ P}}_{p \neq {s}_{{k}_{1}} , {e}_{{k}_{1}}} ( {q}_{{τ}_{1} , p}^{( {k}_{1} )} {{\sum }_{{k}_{2} ∈ K}}_{{k}_{2} \geq {k}_{1}} {{\sum }_{{τ}_{2} ∈ T}}_{{τ}_{2} \neq {τ}_{1}} {q}_{{τ}_{2} , p}^{( {k}_{2} )} ) & ( Equation 8 )\end{matrix}$$

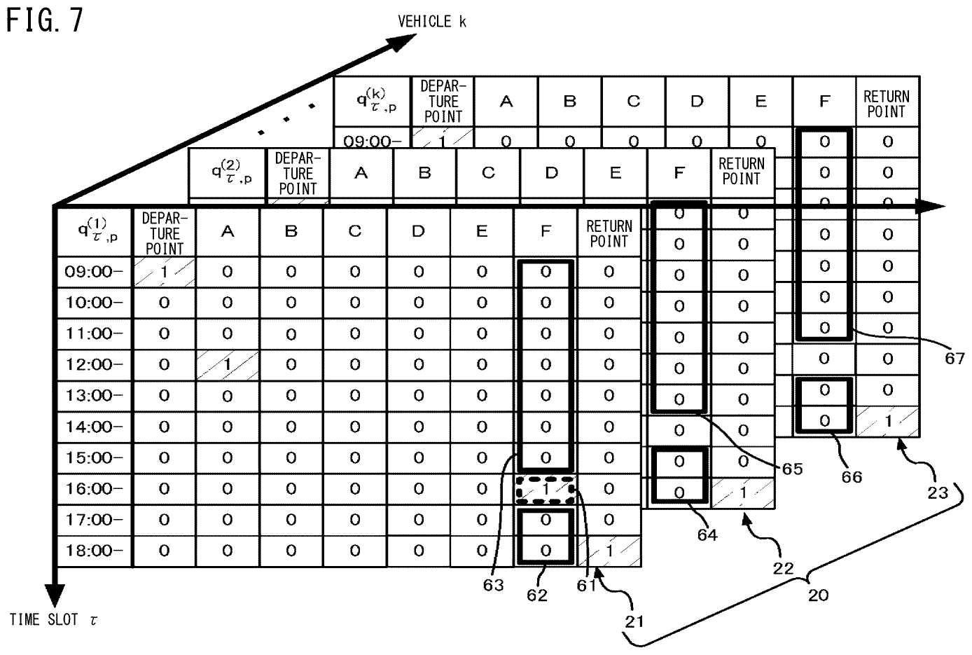

FIG. 7 is a diagram illustrating the fourth function. FIG. 7 shows an example of the delivery plan 21 of the vehicle 1, the delivery plan 22 of the vehicle 2, and the delivery plan 23 of the vehicle V. Note that delivery plans for other vehicles are similarly shown.

Here, constraints are set such that the number of visits of each vehicle to each delivery point should be 1 or less, and when the planned period of a delivery plan is divided into a plurality of time slots, a plurality of vehicles should not visit each delivery point in a plurality of time slots. The Hamiltonian H4 is a penalty function that imposes a penalty if the constraints are not satisfied.

For example, suppose that the vehicle 1 departs from the delivery point F in the time slot from 16:00. In this case, the value of a cell in a frame 61 is 1. Since the number of visits of the vehicle 1 to the delivery point F should be 1 or less, the values of cells in frames 62, 63 must be 0. In addition, a plurality of vehicles are prohibited from visiting the delivery point F. Therefore, the values of cells in frames 64, 65 of the delivery plan 22 must be 0. Likewise, the values of cells in frames 66, 67 of the delivery plan 23 must be 0. The same applies to the delivery plans for vehicles other than the vehicles 1, 2, V. However, the Hamiltonian H4 allows a plurality of vehicles to visit each point in the same time slot.

The Hamiltonian H4 is a function which is 0 when the constraints are satisfied, and whose value (penalty) increases according to a combination that does not satisfy the constraints.

The fourth function can be formulated as Hamiltonian H4 by using the decision variable of equation 3, which indicates whether or not the vehicle k visits the point p in the time slot τ, as 0 or 1. Therefore, the objective function 122 can be optimized by using the quantum computer 200 or an Ising machine.

### [Fifth Function]

The fifth function (Hamiltonian H5) is represented by equation 9 as follows.

$$\begin{matrix}[ Math . 16 ] & \\ {H}_{5} = {\sum }_{{k}_{1} ∈ K} {\sum }_{τ ∈ T} {{\sum }_{p ∈ P}}_{p \neq {s}_{{k}_{1}} , {e}_{{k}_{1}}} ( {q}_{τ , p}^{( {k}_{1} )} {{\sum }_{{k}_{2} ∈ K}}_{{k}_{2} > {k}_{1}} {q}_{τ , p}^{( {k}_{2} )} ) & ( Equation 9 )\end{matrix}$$

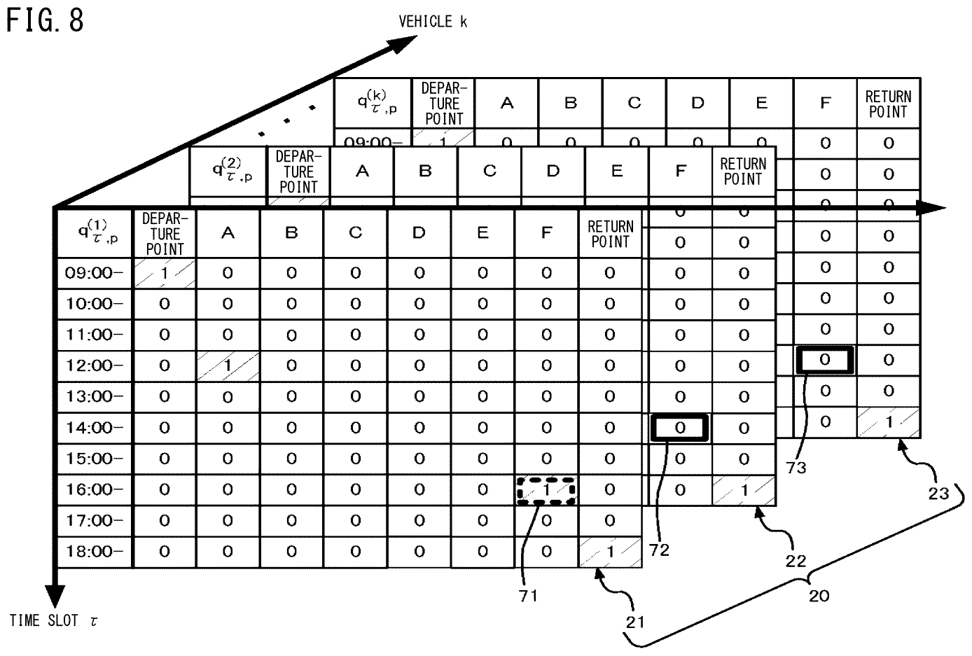

FIG. 8 is a diagram illustrating the fifth function. FIG. 8 shows an example of the delivery plan 21 of the vehicle 1, the delivery plan 22 of the vehicle 2, and the delivery plan 23 of the vehicle V. Note that delivery plans for other vehicles are similarly shown.

The Hamiltonian H5 is a penalty function that has a constraint that a plurality of vehicles should not visit each delivery point in each time slot, and imposes a penalty if the constraint is not satisfied.

For example, suppose that the vehicle 1 departs from the delivery point F in the time slot from 16:00. In this case, the value of a cell in a frame 71 is 1. The other vehicles are prohibited from visiting the delivery point F in the same time slot. Therefore, the value of a cell in a frame 72 of the delivery plan 22 must be 0. In addition, the value of a cell in a frame 73 of the delivery plan 23 must be 0. The same applies to the delivery plans for vehicles other than the vehicles 1, 2, V.

The Hamiltonian H5 is a function which is 0 when the constraint is satisfied, and whose value (penalty) increases according to a combination that does not satisfy the constraint.

The fifth function can be formulated as Hamiltonian H5 by using the decision variable of equation 3, which indicates whether or not the vehicle k visits the point p in the time slot τ, as 0 or 1. Therefore, the objective function 122 can be optimized by using the quantum computer 200 or an Ising machine.

### [Sixth Function]

The sixth function (Hamiltonian H6) is represented by equation 10 as follows.

$$\begin{matrix}[ Math . 17 ] & \\ {H}_{6} = {\sum }_{k ∈ K} {\sum }_{{τ}_{2} ∈ T} ( {q}_{{τ}_{2} , {s}_{k}}^{( k )} {{\sum }_{{τ}_{1} = 1}}^{{τ}_{2} - 1} {\sum }_{p ∈ P} {q}_{{τ}_{1} , p}^{( k )} ) & ( Equation 10 )\end{matrix}$$

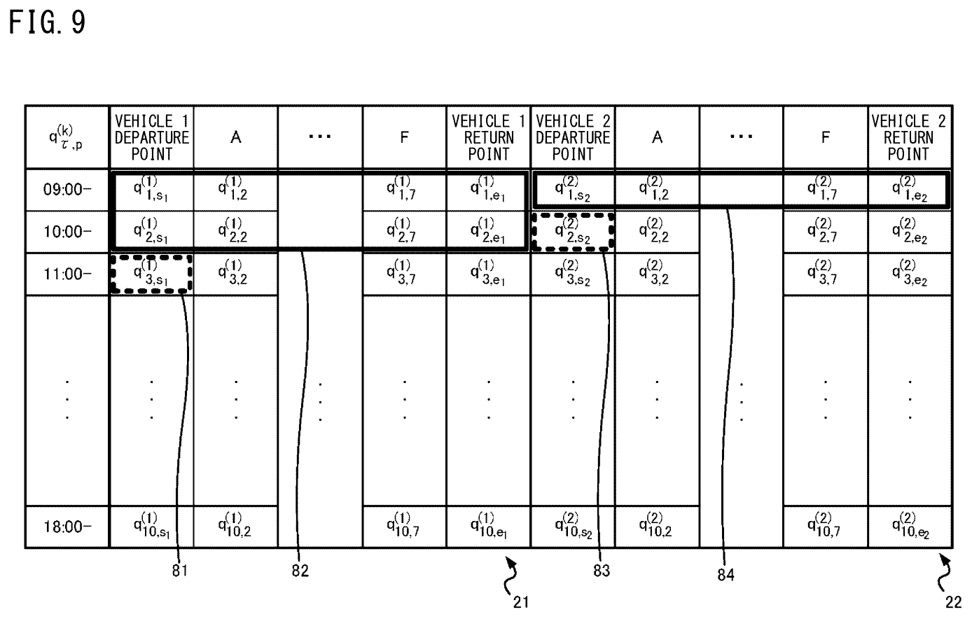

FIG. 9 is a diagram illustrating the sixth function. FIG. 9 illustrates an example of the delivery plan 21 for the vehicle 1 and the delivery plan 22 for the vehicle 2. Note that delivery plans for other vehicles are similarly shown.

The Hamiltonian H6 is a penalty function that has a constraint that each vehicle should not visit the departure point, the delivery point, and the return point before the departure time from the departure point, and imposes a penalty if the constraint is not satisfied.

For example, suppose that the vehicle 1 departs from the departure point in the time slot from 11:00. Therefore, the value of a cell in a frame 81 of the delivery plan 21 is 1. In this case, the vehicle 1 is prohibited from visiting the departure point, the delivery point, and the return point in the time slots before 11:00 (here, time slots from 9:00 and 10:00). Therefore, the values of cells in a frame 82 of the delivery plan 21 must be 0.

Likewise, suppose that the vehicle 2 departs from the departure point at the time slot from 10:00. Therefore, the value of a cell in a frame 83 of the delivery plan 22 is 1. In this case, the vehicle 2 is prohibited from visiting the departure point, the delivery point, and the return point in a time slot before 10:00 (here, time slot from 9:00). Therefore, the values of cells in a frame 84 of the delivery plan 22 must be 0.

The Hamiltonian H6 is a function which is 0 when the constraint is satisfied, and whose value (penalty) increases according to a combination that does not satisfy the constraint. The sixth function can be formulated as Hamiltonian H6 by using the decision variable of equation 3, which indicates whether or not the vehicle k visits the point p in the time slot τ, as 0 or 1. Therefore, the objective function 122 can be optimized by using the quantum computer 200 or an Ising machine.

### [Seventh Function]

The seventh function (Hamiltonian H7) is represented by equation 11 as follows.

$$\begin{matrix}[ Math . 18 ] & \\ {H}_{7} = {\sum }_{k ∈ K} {\sum }_{{τ}_{1} ∈ T} ( {q}_{{τ}_{1} , {e}_{k}}^{( k )} {{\sum }_{{τ}_{2} = {τ}_{1} + 1}}^{W} {\sum }_{p ∈ P} {q}_{{τ}_{2} , p}^{( k )} ) & ( Equation 11 )\end{matrix}$$

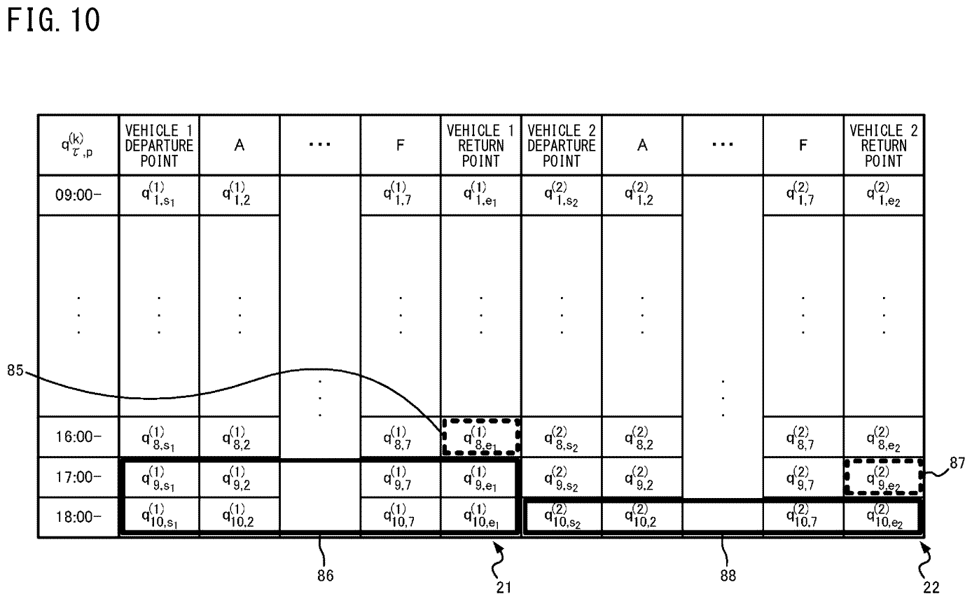

FIG. 10 is a diagram illustrating the seventh function. FIG. 10 shows an example of the delivery plan 21 of the vehicle 1 and the delivery plan 22 of the vehicle 2. Note that delivery plans for other vehicles are similarly shown.

The Hamiltonian H7 is a penalty function that has a constraint that each vehicle should not visit the departure point, the delivery point, and the return point after the arrival time at the return point, and imposes a penalty if the constraint is not satisfied.

For example, suppose that the vehicle 1 arrives at the return point in the time slot from 16:00. Therefore, the value of a cell in a frame 85 of the delivery plan 21 is 1. In this case, the vehicle 1 is prohibited from visiting the departure point, the delivery point, and the return point in the time slots after 16:00 (here, time slots from 17:00 and 18:00). Therefore, the values of cells in a frame 86 of the delivery plan 21 must be 0.

Likewise, suppose that the vehicle 2 arrives at the return point in the time slot from 17:00. Therefore, the value of a cell in a frame 87 of the delivery plan 22 is 1. In this case, the vehicle 2 is prohibited from visiting the departure point, the delivery point, and the return point in the time slot after 17:00 (here, time slot from 18:00). Therefore, the values of cells in a frame 88 of the delivery plan 22 must be 0.

The Hamiltonian H7 is a function which is 0 when the constraint is satisfied, and whose value (penalty) increases according to a combination that does not satisfy the constraint.

The seventh function can be formulated as Hamiltonian H7 by using the decision variable of equation 3, which indicates whether or not the vehicle k visits the point p in the time slot τ, as 0 or 1. Therefore, the objective function 122 can be optimized by using the quantum computer 200 or an Ising machine.

### [Eighth Function]

The eighth function (Hamiltonian H8) is represented by equation 12 as follows.

$$\begin{matrix}[ Math . 19 ] & \\ {H}_{8} = {\sum }_{k ∈ K} {( {\sum }_{τ ∈ T} {q}_{τ , {s}_{k}}^{( k )} - 1 )}^{2} & ( Equation 12 )\end{matrix}$$

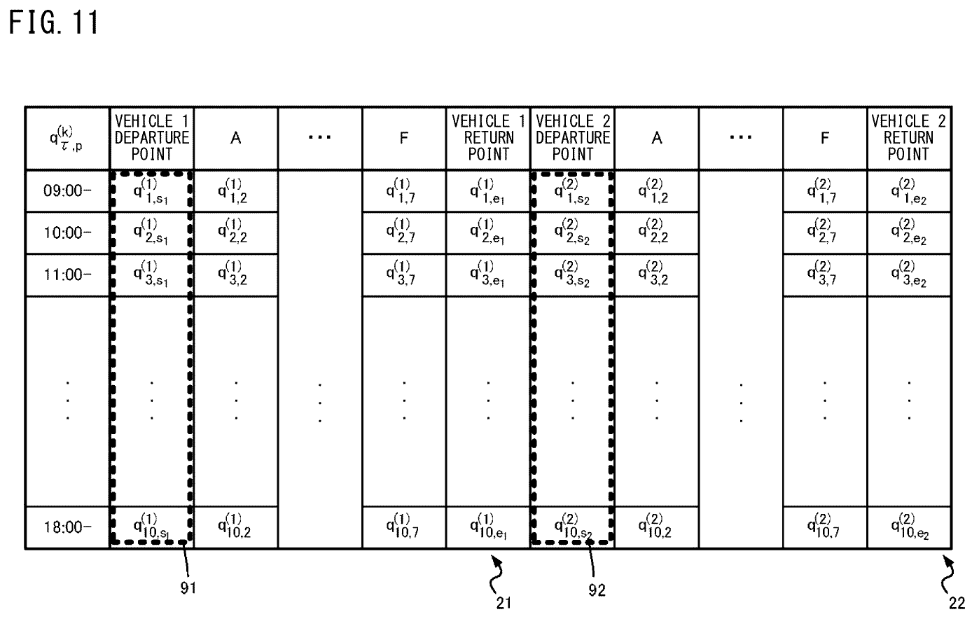

FIG. 11 is a diagram illustrating the eighth function. FIG. 11 shows an example of the delivery plan 21 for the vehicle 1 and the delivery plan 22 for the vehicle 2. Note that delivery plans for other vehicles are similarly shown.

The Hamiltonian H8 is a penalty function that has a constraint that each vehicle should not visit the departure point a plurality of times, and imposes a penalty if the constraint is not satisfied.

For example, the vehicle 1 departs from the departure point only once. Therefore, the sum of the values of cells in a frame 91 of the delivery plan 21 must be 1. Likewise, the vehicle 2 departs from the departure point only once. Therefore, the sum of the values of cells in a frame 92 of the delivery plan 22 must be 1.

The Hamiltonian H8 is a function which is 0 when the constraint is satisfied, and whose value (penalty) increases according to a combination that does not satisfy the constraint. For example, when the sum of the values of the cells in the frame 91 is a value other than 1, the value of the Hamiltonian H8 is not 0.

The eighth function can be formulated as Hamiltonian H8 by using the decision variable of equation 3, which indicates whether or not the vehicle k visits the point p in the time slot τ, as 0 or 1. Therefore, the objective function 122 can be optimized by using the quantum computer 200 or an Ising machine.

### [Ninth Function]

The ninth function (Hamiltonian H9) is represented by equation 13 as follows.

$$\begin{matrix}[ Math . 20 ] & \\ {H}_{9} = {\sum }_{k ∈ K} {( {\sum }_{τ ∈ T} {q}_{τ , {e}_{k}}^{( k )} - 1 )}^{2} & ( Equation 13 )\end{matrix}$$

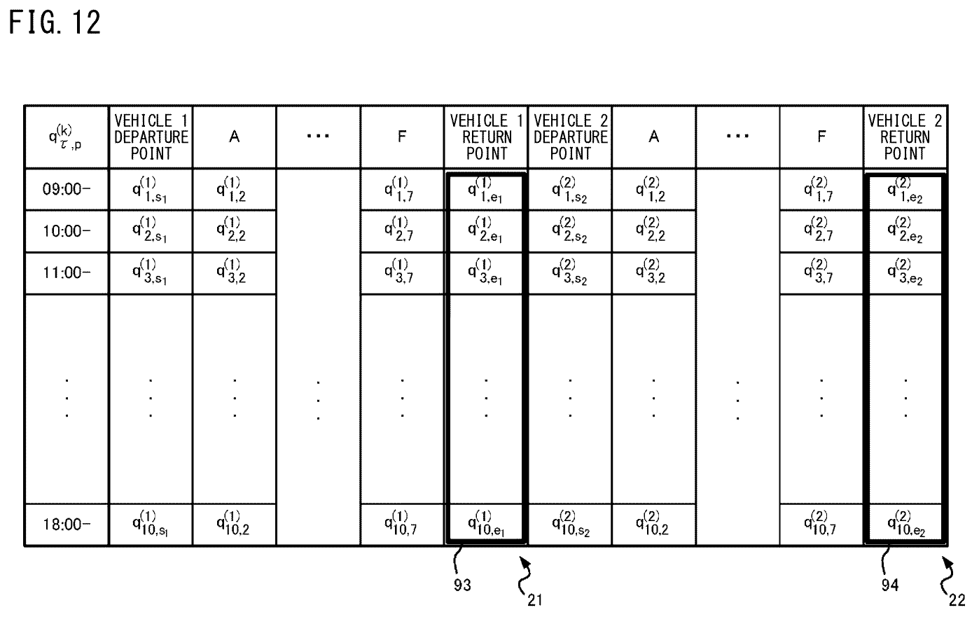

FIG. 12 is a diagram illustrating the ninth function. FIG. 12 shows an example of the delivery plan 21 for the vehicle 1 and the delivery plan 22 for the vehicle 2. Note that delivery plans for other vehicles are similarly shown.

Hamiltonian H9 is a penalty function that has a constraint that each vehicle should not visit the return point a plurality of times, and imposes a penalty if the constraint is not satisfied.

For example, the vehicle 1 arrives at the return point only once. Therefore, the sum of the values of cells in a frame 93 of the delivery plan 21 must be 1. Likewise, the vehicle 2 arrives at the return point only once. Therefore, the sum of the values of cells in a frame 94 of the delivery plan 22 must be 1.

The Hamiltonian H9 is a function which is 0 when the constraint is satisfied, and whose value (penalty) increases according to a combination that does not satisfy the constraint. For example, when the sum of the values of the cells in the frame 93 is a value other than 1, the value of the Hamiltonian H9 is not 0.

The ninth function can be formulated as Hamiltonian H9 by using the decision variable of equation 3, which indicates whether or not the vehicle k visits the point p in the time slot τ, as 0 or 1. Therefore, the objective function 122 can be optimized by using the quantum computer 200 or an Ising machine.

Referring back to FIG. 3, the delivery plan determination unit 132, using the quantum computer 200, optimizes (here, minimizes) the objective function 122 acquired by the objective function acquisition unit 131 to determine the delivery plan for each vehicle. That is, the objective function acquisition unit 131 transmits the QUBO objective function 122 represented by equation 4 to the quantum computer 200 via the communication unit 110. The quantum computer 200 probabilistically calculates the value of the decision variable that minimizes the objective function 122.

The objective function acquisition unit 131 receives the value of the decision variable from the quantum computer 200 via the communication unit 110. The objective function acquisition unit 131 determines the delivery plan based on the value of the decision variable. For example, the objective function acquisition unit 131 determines the delivery plan 20 as shown in FIG. 2 based on the value of the decision variable.

### [Operation of Delivery Plan Determination System 10]

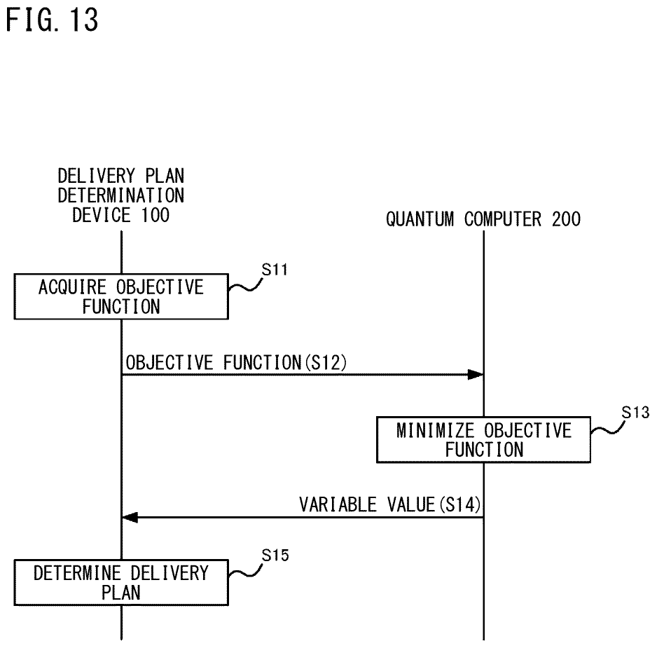

FIG. 13 is a sequence diagram showing an example of the operation of the delivery plan determination system 10 according to Embodiment 1 of the present disclosure.

The delivery plan determination device 100 acquires the objective function 122 (step S11).

The delivery plan determination device 100 transmits the acquired objective function 122 to the quantum computer 200, and the quantum computer 200 receives the objective function 122 (step S12).

The quantum computer 200 calculates the value of the decision variable that minimizes the value of the received objective function 122 (step S13).

The quantum computer 200 transmits the calculated value of the decision variable to the delivery plan determination device 100, and the delivery plan determination device 100 receives the value of the decision variable (step S14).

The delivery plan determination device 100 determines the delivery plan based on the received value of the decision variable (step S15).

As described above, the objective function 122 is optimized by using the annealing type quantum computer 200 or an Ising machine. The objective function 122 includes the first function relating to the required package delivery time and the second function relating to the number of package delivery points. Furthermore, the objective function 122 includes the penalty functions indicated as the third to ninth functions. These penalty functions indicate the constraints for vehicles when the vehicles travel between points. Therefore, it is possible to quickly determine the package delivery plan that optimizes the required package delivery time and the number of package delivery points while satisfying the constraints.

The objective function 122 is indicated by the sum of the functions obtained by multiplying the first function, the second function, the third function, the fourth function, the fifth function, the sixth function, the seventh function, the eighth function, and the ninth function by the predetermined weight coefficients, respectively, as shown in equation 4. For example, by setting the weights for the third through ninth functions to values that are sufficiently larger than the weights for the first and second functions (e.g., 100 to 1000 times larger), the value of 16 can be increased when the constraints are not satisfied. Therefore, the package delivery plan that reliably satisfies the constraints can be determined by minimizing the objective function 122.

### Embodiment 2

In Embodiment 2, a delivery plan determination method in the case where the package delivery time is designated will be described.

The configuration of the delivery plan determination system 10 is the same as that shown in FIG. 1.

Hereinafter, differences from Embodiment 1 will be mainly described.

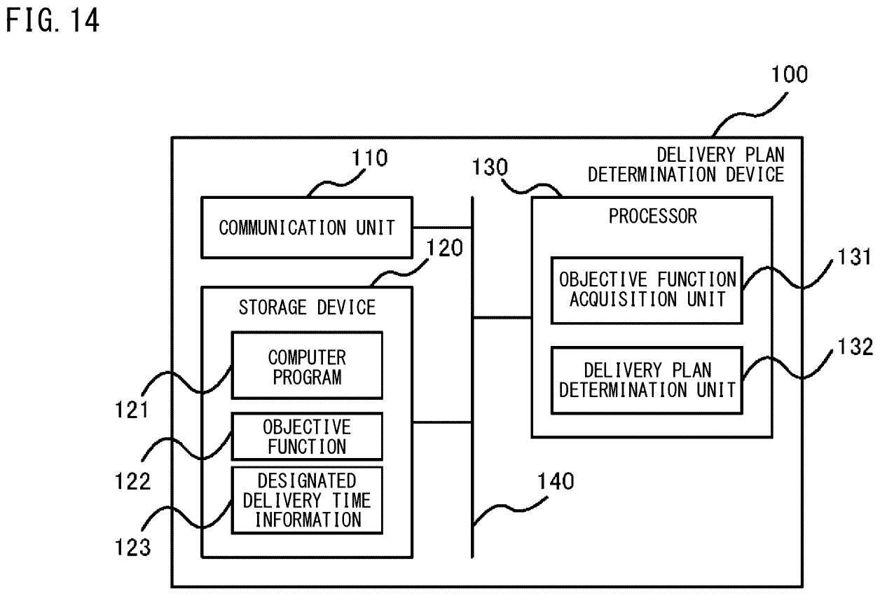

FIG. 14 is a block diagram showing an example of the configuration of the delivery plan determination device 100 according to Embodiment 2 of the present disclosure.

The delivery plan determination device 100 has the same configuration as the delivery plan determination device 100 shown in FIG. 3. However, the storage device 120 further stores designated delivery time information 123 for packages.

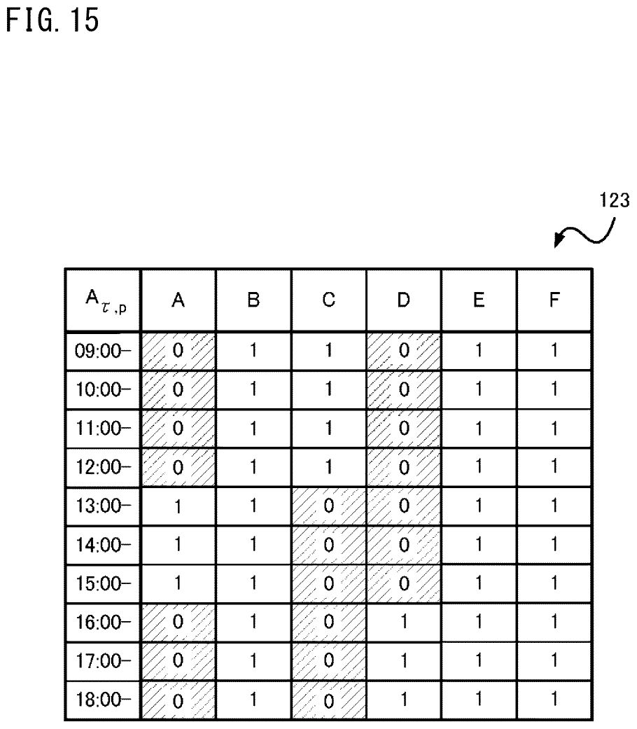

FIG. 15 shows an example of the designated delivery time information 123 for packages.

The designated delivery time information 123 indicates designated delivery times for packages at the respective delivery points. A time slot whose cell has a value of 1 indicates a designated delivery time, and a time slot whose cell has a value of 0 indicates a time other than the designated delivery time. For example, as for the delivery point A, the values of cells in the time slots from 13:00, 14:00, 15:00 are 1, and the values of cells in the other time slots are 0. This indicates that the designated delivery time for packages to the delivery point A is from 13:00 to 16:00. Likewise, the designated delivery time for packages to the delivery point C is from 9:00 to 13:00. In addition, the designated delivery time for packages to the delivery point D is from 16:00 to 19:00.

As for each of the delivery points B, E, F, the values of cells in all time slots are 1. This indicates that no delivery times are designated for the delivery points B, E, F.

With reference to FIG. 3, the delivery plan determination unit 132 fixes the values of some of the decision variables of the objective function 122 to 0, based on the designated delivery time information 123. Hereinafter, the method for fixing the values of the decision variables will be described.

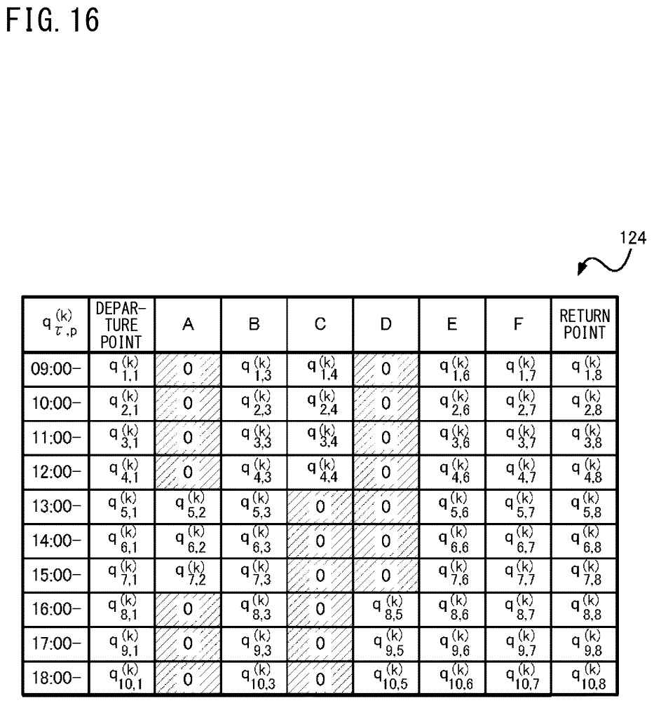

FIG. 16 shows an example of decision variables. A decision variable set 124 indicates a set of decision variables for each point to which the vehicle k may travel and for each time slot. The decision variable set 124 is the same for all vehicles except for the value of the subscript k.

The delivery plan determination unit 132 fixes, to 0, the values of decision variables corresponding to the cells whose values are 0 in the designated delivery time information 123. For example, in the designated delivery time information 123 shown in FIG. 15, as for the delivery point A, the values of cells in the time slots from 9:00, 10:00, 11:00, 12:00, 16:00, 17:00, and 18:00 are 0. Therefore, as shown in FIG. 16, the delivery plan determination unit 132 fixes, to 0, the values of decision variables corresponding to the time slots from 9:00, 10:00, 11:00, 12:00, 16:00, 17:00, and 18:00 of the delivery point A. Thus, a delivery plan in which no vehicle visits the delivery point A in these time slots can be determined.

The delivery plan determination unit 132 similarly fixes the values of decision variables for the other delivery points.

The delivery plan determination unit 132 transmits the decision variable set 124 in which some values are fixed to 0, and the objective function 122 to the quantum computer 200.

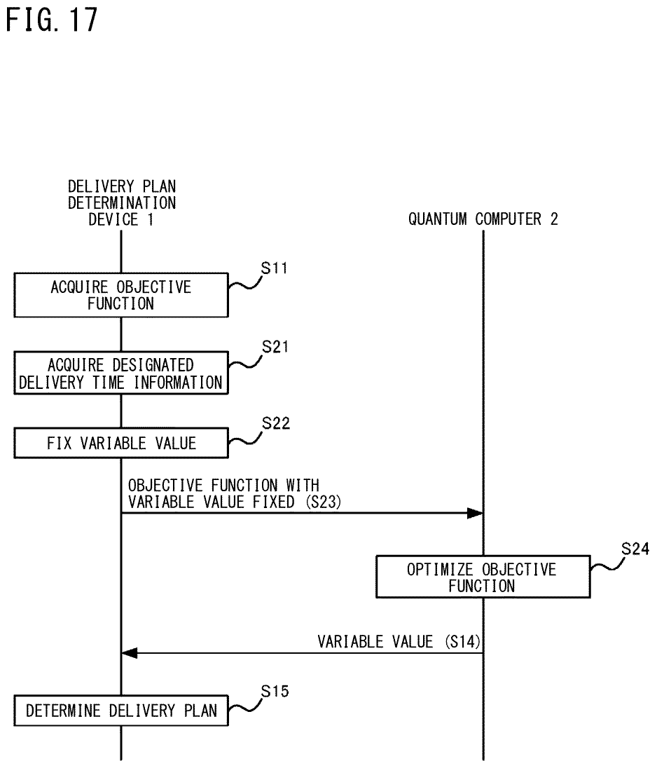

FIG. 17 is a sequence diagram showing an example of the operation of the delivery plan determination system 10 according to Embodiment 2 of the present disclosure. The same step numbers are used for steps similar to those shown in FIG. 13.

The delivery plan determination device 100 acquires the objective function 122 (step S11).

The delivery plan determination device 100 acquires the designated delivery time information 123 (step S21). The delivery plan determination unit 132 in the delivery plan determination device 100 may acquire the designated delivery time information 123 by reading out the same from the storage device 120. The delivery plan determination unit 132 may acquire the designated delivery time information 123 by receiving, through the I/O interface, the designated delivery time information 123 entered by the user through the input device.

Based on the acquired designated delivery time information 123, the delivery plan determination unit 132 of the delivery plan determination device 100 fixes some decision variables among the decision variables of the objective function 122 to 0 (step S22).

The delivery plan determination unit 132 of the delivery plan determination device 100 transmits the decision variable set 124 in which some decision variables are fixed to 0, and the objective function 122 to the quantum computer 200. The quantum computer 200 receives the decision variable set 124 and the objective function 122 (step S23).

The quantum computer 200 calculates the values of decision variables that minimize the objective function 122 without changing the fixed values of 0 indicated in the decision variable set 124 (step S24).

The quantum computer 200 transmits the calculated values of the decision variables to the delivery plan determination device 100, and the delivery plan determination device 100 receives the values of the decision variables (step S14).

The delivery plan determination device 100 determines the delivery plan based on the received values of the decision variables (step S15).

As described above, the number of the decision variables whose values should be determined can be reduced. Thus, a delivery plan in which packages are not delivered during a period in which delivery is prohibited, can be quickly determined.

### Modification

The fourth function is a penalty function including constraints that the number of visits of each vehicle to each delivery point should be 1 or less, and that when the planned time of the delivery plan is divided into a plurality of time slots, a plurality of vehicles are prohibited from visiting each delivery point in a plurality of time slots.

However, there is a case where a plurality of packages with different designated delivery times are delivered to the same delivery point. In such a case, one vehicle may visit the delivery point twice or more, or a plurality of vehicles may visit the delivery point in a plurality of time slots, which does not satisfy the constraints indicated in the fourth function.

Therefore, in this modification, it is assumed that a delivery point is associated with a package and a designated delivery time of this package. In other words, if packages have different designated delivery times even for the same delivery point, the delivery point is treated as different delivery points. For example, it is assumed that a package P1 with a designated delivery time from 9:00 to 12:00 and a package P2 with a designated delivery time from 11:00 to 15:00 are planned to be delivered to the delivery point A. In this case, the objective function is optimized in the same manner as in the above embodiments, with the delivery point A of the package P1 being a delivery point A1 and the delivery point A of the package P2 being a delivery point A2.

Thus, it is possible to determine a delivery plan for delivering packages with different designated delivery times to the same delivery point without being restricted by the number of visits according to the fourth function.

### Additional Note

Although the delivery plan determination system 10 according to the embodiments of the present disclosure has been described, the present disclosure is not limited to the embodiments.

For example, in the above embodiments, the combinatorial optimization problem to be solved by the quantum computer 200 or an Ising machine is formulated by QUBO, but the combinatorial optimization problem may be formulated by an Ising model. The Ising model is identical to QUBO except that the value that the decision variable can take is 1 or −1. Therefore, the Ising model and the QUBO are mutually convertible.

In addition, some or all of the components constituting the delivery plan determination device 100 may be implemented by hardware such as one or more FPGAs (Field Programmable Gate Arrays) or ASICs (Application Specific Integrated Circuits).

The above computer program may be distributed by being stored in a non-transitory computer-readable recording medium such as an HDD, a CD-ROM, or a semiconductor memory, for example. Alternatively, the computer program may be distributed by being transmitted through electric communication lines, wireless/wired communication lines, a network such as the Internet, data broadcasting, or the like.

The delivery plan determination device 100 may be realized by a plurality of computers or a plurality of processors.

In addition, some or all of the functions of the delivery plan determination device 100 may be provided through cloud computing. That is, some or all of the functions of the delivery plan determination device 100 may be realized by a cloud server.

Moreover, at least some of the above embodiments and modifications may be combined as appropriate.

The present invention can be realized not only as the delivery plan determination device 100 including the above characteristic processing units, but also as a delivery plan determination method having such characteristic processing steps or as a computer program for causing a computer to execute the steps. Furthermore, the present invention can be realized as a semiconductor integrated circuit that realizes a part or the entirety of the delivery plan determination device 100, or as a delivery plan determination system including the delivery plan determination device 100.

The embodiments disclosed herein are merely illustrative and not restrictive in all aspects. The scope of the present invention is defined by the scope of the claims rather than the meaning described above, and is intended to include meaning equivalent to the scope of the claims and all modifications within the scope.

### REFERENCE SIGNS LIST

10 delivery plan determination system
20, 21, 22, 23, 24 delivery plan
31, 32, 33, 34, 41, 42, 43, 51, 52, 53, 54, 55, 56, 61, 62, 63, 64, 65, 66, 67, 71, 72, 73, 81, 83, 84, 85, 86, 87, 88, 91, 92, 93, 94 frame
100 delivery plan determination device
110 communication unit
120 storage device
121 computer program
122 objective function
123 designated delivery time information
124 decision variable set
130 processor
131 objective function acquisition unit
132 delivery plan determination unit
140 internal bus
200 quantum computer
300 network

1. A delivery plan determination device that determines a delivery plan for delivering packages using a plurality of vehicles from a departure point to a return point via a package delivery point, comprising:
an objective function acquisition unit configured to acquire an objective function including a first function, a second function, a third function, a fourth function, a fifth function, a sixth function, a seventh function, an eighth function, and a ninth function described below; and
a delivery plan determination unit configured to determine the delivery plan by optimizing the objective function using an annealing type quantum computer or an Ising machine:
first function: a function indicating a required package delivery time;
second function: a function indicating the number of the delivery points;
third function: a penalty function that prohibits each vehicle from traveling, in a time shorter than a required travel time, between points to which each vehicle may travel;
fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots;
fifth function: a penalty function that prohibits the plurality of vehicles from visiting each delivery point in each time slot;
sixth function: a penalty function that prohibits each vehicle from visiting the departure point, the delivery point, and the return point before a departure time of the vehicle from the departure point;
seventh function: a penalty function that prohibits each vehicle from visiting the departure point, the delivery point, and the return point after a return time to the return point;
eighth function: a penalty function that prohibits each vehicle from visiting the departure point a plurality of times;
ninth function: a penalty function that prohibits each vehicle from visiting the return point a plurality of times.

2. The delivery plan determination device according to claim 1, wherein
the objective function is represented by a sum of functions obtained by multiplying the first function, the second function, the third function, the fourth function, the fifth function, the sixth function, the seventh function, the eighth function, and the ninth function by predetermined weight coefficients, respectively.

3. The delivery plan determination device according to claim 1, wherein the third function is represented by H3 as follows:
$$[ Math . 1 ]$$
$${H}_{3} = {\sum }_{k ∈ K} {\sum }_{{τ}_{1} ∈ T} {{\sum }_{{p}_{1} ∈ P}}_{{p}_{1} \neq {e}_{k}} ( {q}_{{τ}_{1} , {p}_{1}}^{( k )} {{\sum }_{{p}_{2} ∈ P}}_{{p}_{2} \neq {p}_{1} , {s}_{k}} {{\sum }_{{τ}_{2} = {τ}_{1}}}^{{τ}_{1} + {c}_{{p}_{1} {p}_{2}}^{( k , {τ}_{1} )} - 1} {q}_{{τ}_{2} , {p}_{2}}^{( k )} )$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${s}_{k} : departure point of vehicle k ( element of P )$$
$${e}_{k} : return point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix}$$
$${( {c}_{{p}_{1} {p}_{2}}^{( k , {τ}_{1} )} )}_{1 \leq {p}_{1} \neq {p}_{2} \leq N} : number of time slots required after departure from$$
$$point {p}_{1} and before departure from next point {p}_{2}$$
$${c}_{{p}_{1} {p}_{2}}^{( k , {τ}_{1} )} = ⌈ \frac{{t}_{{p}_{1} {p}_{2}}^{( move )} + {t}_{{p}_{2}}^{( wait )} + {t}_{{p}_{2}}^{( work )} + {t}_{k}^{( rest )}}{Δ t} ⌉$$
$${t}_{{p}_{1} {p}_{2}}^{( move )} : travel time from point {p}_{1} to point {p}_{2}$$
$${t}_{{p}_{2}}^{( wait )} : waiting time at point {p}_{2}$$
$${t}_{{p}_{2}}^{( work )} : work time at point {p}_{2}$$
$${t}_{k}^{( rest )} : break time designated to vehicle k$$
$$Δ t : time in time slot .$$

4. The delivery plan determination device according to claim 1, wherein the fourth function is represented by H4 as follows:
$$[ Math . 2 ]$$
$${H}_{4} = {\sum }_{{k}_{1} ∈ K} {\sum }_{{τ}_{1} ∈ T} {{\sum }_{p ∈ P}}_{p \neq {s}_{{k}_{1}} , {e}_{{k}_{1}}} ( {q}_{{τ}_{1} , p}^{( {k}_{1} )} {{\sum }_{{k}_{2} ∈ K}}_{{k}_{2} \geq {k}_{1}} {{\sum }_{{τ}_{2} ∈ T}}_{{τ}_{2} \neq {τ}_{1}} {q}_{{τ}_{2} , p}^{( {k}_{2} )} )$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${s}_{k} : departure point of vehicle k ( element of P )$$
$${e}_{k} : return point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix} .$$

5. The delivery plan determination device according to claim 1, wherein the fifth function is represented by H5 as follows:
$$[ Math . 3 ]$$
$${H}_{5} = {\sum }_{{k}_{1} ∈ K} {\sum }_{τ ∈ T} {{\sum }_{p ∈ P}}_{p \neq {s}_{{k}_{1}} , {e}_{{k}_{1}}} ( {q}_{τ , p}^{( {k}_{1} )} {{\sum }_{{k}_{2} ∈ K}}_{{k}_{2} > {k}_{1}} {q}_{τ , p}^{( {k}_{2} )} )$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${s}_{k} : departure point of vehicle k ( element of P )$$
$${e}_{k} : return point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix} .$$

6. The delivery plan determination device according to claim 1, wherein the sixth function is represented by H6 as follows:
$$[ Math . 4 ]$$
$${H}_{6} = {\sum }_{k ∈ K} {\sum }_{{τ}_{2} ∈ T} ( {q}_{{τ}_{2} , {s}_{k}}^{( k )} {{\sum }_{{τ}_{1} = 1}}^{{τ}_{2} - 1} {\sum }_{p ∈ P} {q}_{{τ}_{1} , p}^{( k )} )$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${s}_{k} : departure point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix} .$$

7. The delivery plan determination device according to claim 1, wherein the seventh function is represented by H7 as follows:
$$[ Math . 5 ]$$
$${H}_{7} = {\sum }_{k ∈ K} {\sum }_{{τ}_{1} ∈ T} ( {q}_{{τ}_{1} , {e}_{k}}^{( k )} {{\sum }_{{τ}_{2} = {τ}_{1} + 1}}^{W} {\sum }_{p ∈ P} {q}_{{τ}_{2} , p}^{( k )} )$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${e}_{k} : return point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix} .$$

8. The delivery plan determination device according to claim 1, wherein the eighth function is represented by H8 as follows:
$$[ Math . 6 ]$$
$${H}_{8} = {\sum }_{k ∈ K} {( {\sum }_{τ ∈ T} {q}_{τ , {s}_{k}}^{( k )} - 1 )}^{2}$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${s}_{k} : departure point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix} .$$

9. The delivery plan determination device according to claim 1, wherein the ninth function is represented by H9 as follows:
$$[ Math . 7 ]$$
$${H}_{9} = {\sum }_{k ∈ K} {( {\sum }_{τ ∈ T} {q}_{τ , {e}_{k}}^{( k )} - 1 )}^{2}$$
$$where$$
$$τ ∈ T = \{ 1 , 2 , … , W \} : time slot$$
$$k ∈ K = \{ 1 , 2 , … , V \} : vehicle$$
$$p ∈ P = \{ 1 , 2 , … , N \} : point$$
$${e}_{k} : return point of vehicle k ( element of P )$$
$${q}_{τ , p}^{( k )} = \{ \begin{matrix}1 : vehicle k departs from point p in time slot τ \\ 0 : vehicle k does not depart from point p in time slot τ\end{matrix} .$$

10. The delivery plan determination device according to claim 1, wherein the delivery point is associated with a package and a designated delivery time of the package.

11. The delivery plan determination device according to claim 1, wherein
the objective function includes a decision variable that indicates, with two values, whether or not each vehicle visits each delivery point in each time slot, and
the delivery plan determination unit optimizes the objective function after determining, based on a designated delivery time of a package, the value of a decision variable other than the designated delivery time of the package at the delivery point to a value corresponding to no visit.

12. A delivery plan determination method for determining a delivery plan for delivering packages using a plurality of vehicles from a departure point to a return point via a package delivery point, the method comprising:
acquiring, by a delivery plan determination device, an objective function including a first function, a second function, a third function, a fourth function, a fifth function, a sixth function, a seventh function, an eighth function, and a ninth function described below; and
determining, by the delivery plan determination device, the delivery plan by optimizing the objective function using an annealing type quantum computer or an Ising machine:
first function: a function indicating a required package delivery time;
second function: a function indicating the number of the delivery points;
third function: a penalty function that prohibits each vehicle from traveling, in a time shorter than a required travel time, between points to which each vehicle may travel;
fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots;
fifth function: a penalty function that prohibits the plurality of vehicles from visiting each delivery point in each time slot;
sixth function: a penalty function that prohibits each vehicle from visiting the departure point, the delivery point, and the return point before a departure time of the vehicle from the departure point;
seventh function: a penalty function that prohibits each vehicle from visiting the departure point, the delivery point, and the return point after a return time to the return point;
eighth function: a penalty function that prohibits each vehicle from visiting the departure point a plurality of times;
ninth function: a penalty function that prohibits each vehicle from visiting the return point a plurality of times.

13. A computer program for causing a computer to function as a delivery plan determination device that determines a delivery plan for delivering packages using a plurality of vehicles from a departure point to a return point via a package delivery point, the program causing the computer to function as:
an objective function acquisition unit configured to acquire an objective function including a first function, a second function, a third function, a fourth function, a fifth function, a sixth function, a seventh function, an eighth function, and a ninth function described below; and
a delivery plan determination unit configured to determine the delivery plan by optimizing the objective function using an annealing type quantum computer or an Ising machine:
first function: a function indicating a required package delivery time;
second function: a function indicating the number of the delivery points;
third function: a penalty function that prohibits each vehicle from traveling, in a time shorter than a required travel time, between points to which each vehicle may travel;
fourth function: a penalty function that, in a case where the number of visits of each vehicle to each delivery point is one or less and a planned time of the delivery plan is divided into a plurality of time slots, prohibits a plurality of vehicles from visiting each delivery point in a plurality of time slots;
fifth function: a penalty function that prohibits the plurality of vehicles from visiting each delivery point in each time slot;
sixth function: a penalty function that prohibits each vehicle from visiting the departure point, the delivery point, and the return point before a departure time of the vehicle from the departure point;
seventh function: a penalty function that prohibits each vehicle from visiting the departure point, the delivery point, and the return point after a return time to the return point;
eighth function: a penalty function that prohibits each vehicle from visiting the departure point a plurality of times;
ninth function: a penalty function that prohibits each vehicle from visiting the return point a plurality of times.
